(19) United States
(12) Patent Application Publication
(10) Pub. No.: US 2014/0074913 A1
(43) Pub. Date: Mar. 13, 2014

(54) CLIENT-SIDE IMAGE RENDERING IN A CLIENT-SERVER IMAGE VIEWING ARCHITECTURE

(71) Applicant: Calgary Scientific Inc., Calgary (CA)

(72) Inventor: David Christopher Claydon, Calgary (CA)

(73) Assignee: Calgary Scientific Inc., Calgary (CA)

(21) Appl. No.: 14/022,360

(22) Filed: Sep. 10, 2013

Related U.S. Application Data
(60) Provisional application No. 61/698,838, filed on Sep. 10, 2012.
(60) Provisional application No. 61/729,588, filed on Nov. 24, 2012.

(51) Int. Cl. H04L 29/06

(52) U.S. Cl. CPC H04L 67/42
USPC 709/203

(57) ABSTRACT

Systems and methods within a remote access environment that enable a client device that is remotely accessing, e.g., medical images, to seamlessly switch from client-side rendering of image data to server-side rendering of the image data and vice-versa. Distributed image processing may be provided whereby image data may be streamed to, and processed by the client device (client-side rendering), or may be processed remotely at the server and downloaded to the client device for display (server-side rendering). The switching between the two modes may be based on predetermined criteria, such as network bandwidth, processing power the client device, type of imagery to be displayed. The environment also provides for collaboration among plural client devices where at least one of the plural client devices is performing client-side rendering.

This application claims priority to U.S. Provisional Patent Application No. 61/698,838, filed Sep. 10, 2012, and U.S. Provisional Patent Application No. 61/729,588, filed Nov. 24, 2012, both entitled “IMAGE VIEWING ARCHITECTURE HAVING SEAMLESS SWITCHING BETWEEN CLIENT-SIDE IMAGE RENDERING AND SERVER-SIDE IMAGE RENDERING.” The disclosures of the above-referenced applications are incorporated herein by referenced in their entireties.

### BACKGROUND

In a client-server architecture, server-side rendering provides for image generation at a server, where rendered images are transmitted to a client device for display and viewing. Server-side rendering enables devices, such as mobile devices having relatively low computing power to display fairly complex images. In contrast, client-side rendering is where a client device processes data communicated from a server to render images using resources residing on the client device to update the display.

In complex imaging applications, rendering is typically performed by servers; however, bandwidth availability can limit the scalability of such operations. Consequently, as mobile clients have increased CPU power, it has become more practical to provide a degree of client-side rendering of downloaded data. However in systems that switch between client-side and server-side rendering, often the switching creates visual artifacts, a pause in the display, or other user-perceptible results that detract from the user experience.

In addition, collaboration among multiple client devices during an imaging application session is typically accomplished by synchronizing a view generated by server-rendered images. Such collaboration sessions may not optimally utilize the capabilities of the client devices or network connections.

### SUMMARY

Disclosed herein are systems and methods for seamless switching between server-side and client-side image rendering. In accordance with an aspect of the present disclosure, there is disclosed a method of client-server synchronization of a view of image data during client-side image data rendering. The method may include performing client-side rendering of the image data and updating an application state to indicate aspects of a current view being displayed on the client device; retaining a representation of a current view in memory at the client device; writing the current view into the application state; and communicating the application state from the client device to server.

In accordance with other aspects, there is provided a method of client-to-server synchronization by which a client device seamlessly switches from client-side rendering of image data to server-side rendering of image data or vice-versa. In the method, at least a portion of the image data being downloaded from a server to the client device, The method may include updating an application state to indicate aspects of a current view being displayed on the client device; and retaining a representation of a current view in memory at the client device. When performing client-side rendering, switching the client device to server-side rendering of the image data may include writing the current view into the application state; and communicating the application state from the client device to server for utilization of the application state at the server to begin server-side rendering of the image synchronized with the current view. When performing server-side rendering, switching the client device to client-side rendering of the image data may include communicating the application state from the server; and utilizing differences in the application state at the client device to begin client-side rendering of the image data such that the client-side rendering of the image data is synchronized with a last rendered view provided by the server.

According to yet other aspects, there is disclosed a method of dynamic synchronization of images by each of plural client devices. The method may include transferring image data from a server to each of the plural client devices, the image data being rendered by each of the plural client devices for display at each of the plural client devices; updating an application state at each of the plural client devices to indicate a display state associated with the images being displayed at each of the plural client devices; continuously communicating the application state among the plural client devices and the server; and synchronizing the currently displayed image at each of the plural client devices in accordance with the display state at one of the plural client devices.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagram illustrating an environment for image data viewing and collaboration via a computer network;

FIG. 2 is a simplified block diagram illustrating an operation of the remote access program in cooperation with a state model;

FIG. 3 illustrates an operational flow that may seamlessly switch from client-side rendering to server-side rendering in the environment of FIGS. 1 and 2;

FIG. 4 illustrates an operational flow whereby a client device may seamlessly switch from server-side rendering to client-side rendering in the environment of FIGS. 1 and 2;

FIG. 5 illustrates an operational flow of collaboration among plural client devices where at least one of the client devices is performing client-side rendering;

FIG. 6 illustrates an alternative implementation of the image data viewing and collaboration environment; and

FIG. 7 illustrates an exemplary device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

Overview

In accordance with aspects of the present disclosure, in a remote access environment, a client device that is remotely accessing images may be provided with a mechanism to seamlessly switch from client-side rendering of image data to server-side rendering of the image data and vice-versa. The present disclosure provides for distributed image processing whereby image data may be streamed to, and processed by the client device (client-side rendering), or may be processed remotely at the server and downloaded to the client device for display (server-side rendering). The switching between the two modes may be manually implemented by the user, or may be based on predetermined criteria, such as network bandwidth, processing power the client device, type of imagery to be displayed (e.g., 2D, 3D, Maximum Intensity Projection (MIP)/Multi-Planar Reconstruction (MPR)), etc. The present disclosure further provides for collaboration among client devices where at least one of the client devices is performing client-side rendering.

### Example Environment

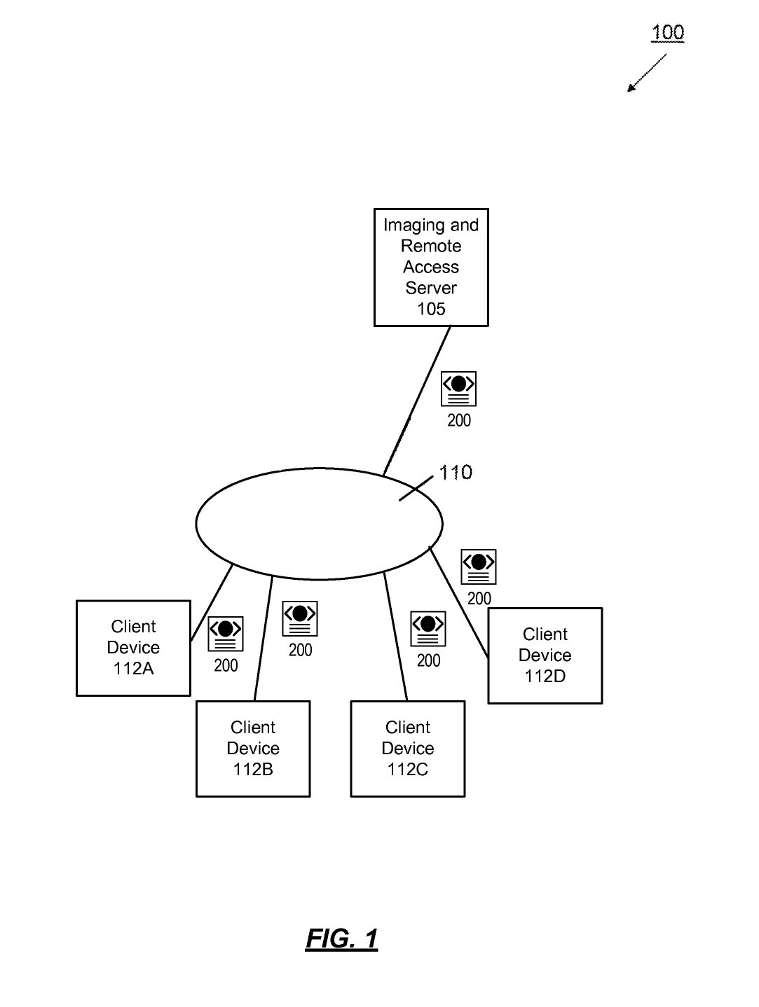

With the above overview as an introduction, reference is now made to FIG. 1 where there is illustrated an environment 100 for image data viewing and collaboration via a computer network. The environment 100 may provide for image data viewing and collaboration. An imaging and remote access server 105 may provide a mechanism to access images data residing within a database (not shown). The imaging and remote access server 105 may include an imaging application that processes the image data for viewing by one or more end users using one of client devices 112A, 112B, 112C or 112N.

The imaging and remote access server 105 is connected, for example, via a computer network 110 to the client devices 112A, 112B. In accordance with implementations of the disclosure, the imaging and remote access server 105 may include a server remote access program that is used to connect various client devices (described below) to applications, such as a medical application provided by the imaging and remote access server 105.

The above-mentioned server remote access program may optionally provide for connection marshalling and application process management across the environment 100. The server remote access program may field connections from and the imaging application provided by the imaging and remote access server 105.

The client devices 112A, 112B, 112C and 112N may be wireless handheld devices such as, for example, an IPHONE, an ANDROID-based device, a tablet device or a desktop/notebook personal computer that are connected by the communication network 110 to the server 102. It is noted that the connections to the communication network 110 may be any type of connection, for example, Wi-Fi (IEEE 802.11x), WiMax (IEEE 802.16), Ethernet, 3G, 4G, etc.

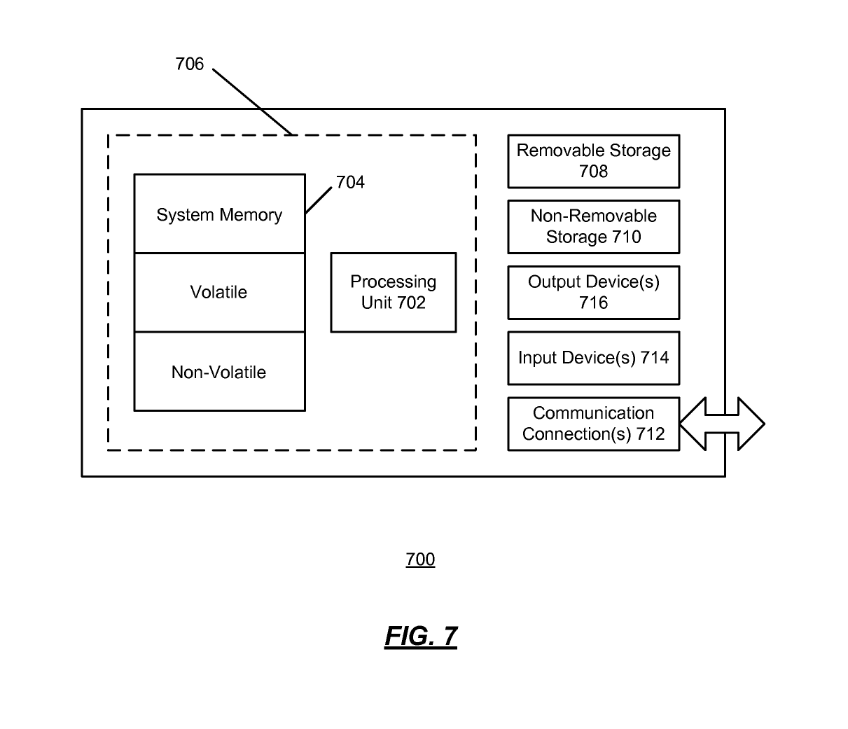

FIG. 1 illustrates four client devices 112A, 112B, 112C and 112N. It is noted that the present disclosure is not limited to four client devices and any number of client devices may operate within the environment 100, as will be further described in FIG. 7.

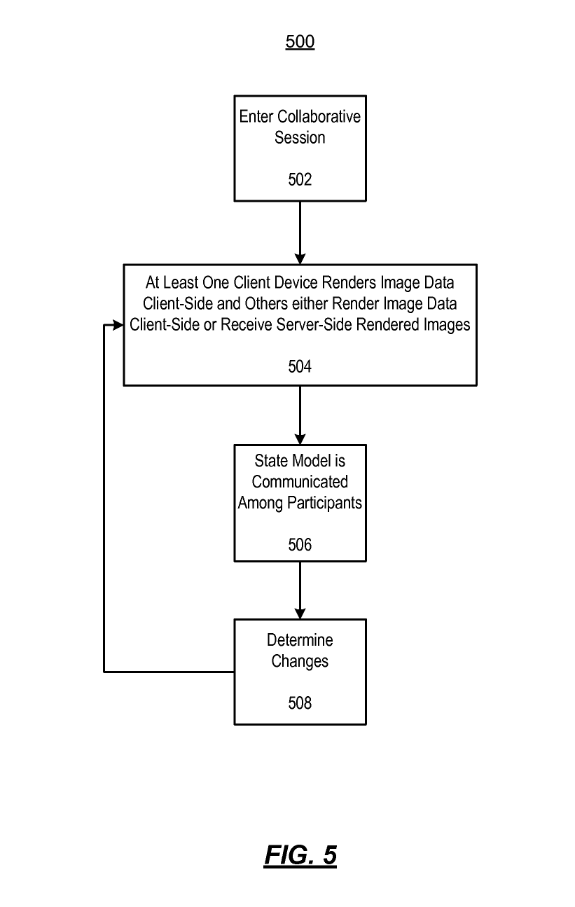

Further, in accordance with aspects of the present disclosure, two or more client devices may collaboratively interact in a collaborative session with the image data that is communicated from the imaging and remote access server 105. The image data may be rendered at the imaging and remote access server 105 or the image data may be rendered at the client devices. As such, by communicating a state model 200 between each of the client devices 112A, 112B, 112C or 112N participating in the collaborative session, each of the participating client devices 112A, 112B, 112C or 112N may present a synchronized view of the display of the image data. Additional details of collaboration among two or more of the client devices 112A, 112B, 112C and 112N is described below with reference to FIG. 5.

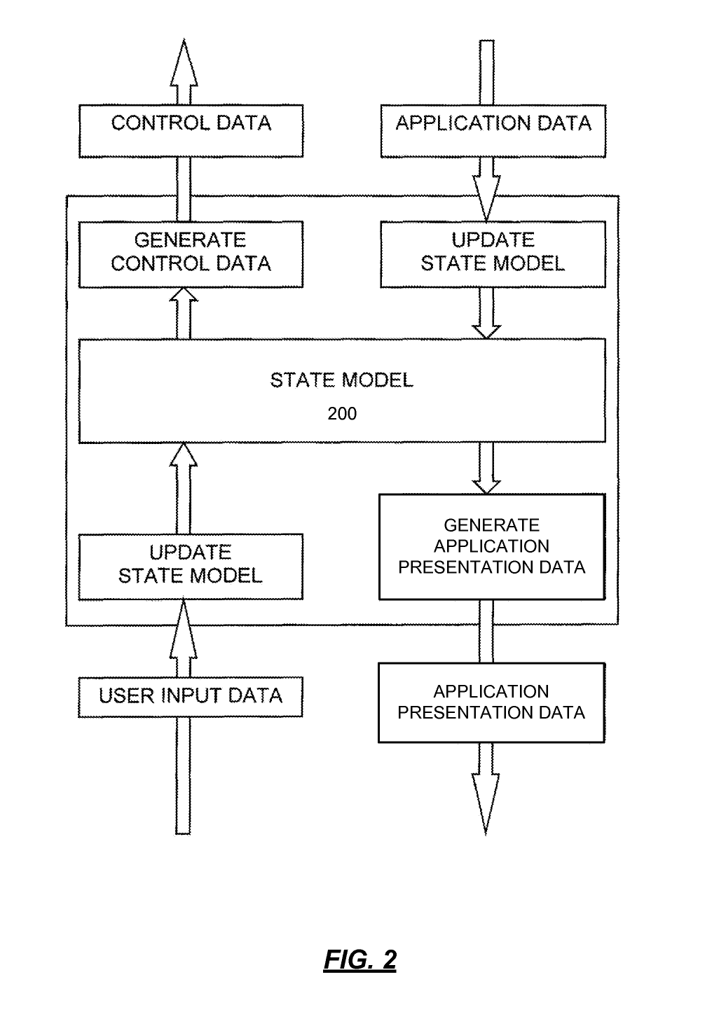

As illustrated in FIG. 2, the state model 200 contains application state information that is updated in accordance with user input data received from a user interface program or imagery currently being displayed by the client device 112A, 112B, 112C or 112N. The server remote access program also updates the state model 200 in accordance with the screen or application data, generates presentation data in accordance with the updated state model, and provides the same to the client device 112A, 112B, 112C or 112N for display. In the environment of the present disclosure, the state model may contain information about images being viewed by a user of the client device 112A, 112B, 112C or 112N, i.e. the current view. This information may be used when rendering of image data switches between server-side and client-side and vice versa. In particular, information about the current view is used by the client device 112A, 112B, 112C or 112N in order to begin client-side rendering when switching to from server-side rendering. Likewise, the information about the current view is used by the imaging and remote access server 105 when switching to server-side rendering, so the imaging and remote access server 105 can begin rendering from the last image rendered at the client device 112A, 112B, 112C or 112N. Thus, the environment 100 utilizes the state model as a mechanism of client-server synchronization to seamlessly switch from client-side rendering of image data to server-side rendering of the image data and vice-versa.

When rendering is performed client-side, image data is streamed from, e.g., the imaging and remote access server 105 to the client device 112A, 112B, 112C or 112N. The client device may then render the image data locally for display. When rendering is performed server-side, the images are rendered at the server 102 and communicated by the server remote access program 111B to the to the client device 112A, 112B, 112C or 112N via the client remote access program 121A, 121B, 121C, 121N.

Exemplary Medical Imaging Environment

In some implementations, the image data may be medical image data (e.g., CT or MR scans) that is received by the client. The CT or MR scans typically comprise a 3D data set that is a group of dozens to hundreds of images or “slices.” The slices are acquired in a regular pattern (e.g., one slice every unit distance) when forming the data set. The slices are rendered into an image by defining a viewing angle and rendering each pixel about the defined viewing angle. The image is then provided to the client for display. An end user, through a user interface application, may zoom or pan the displayed image to zoom in on a particular region or pan around if the image does not fit into a display area of the client device.

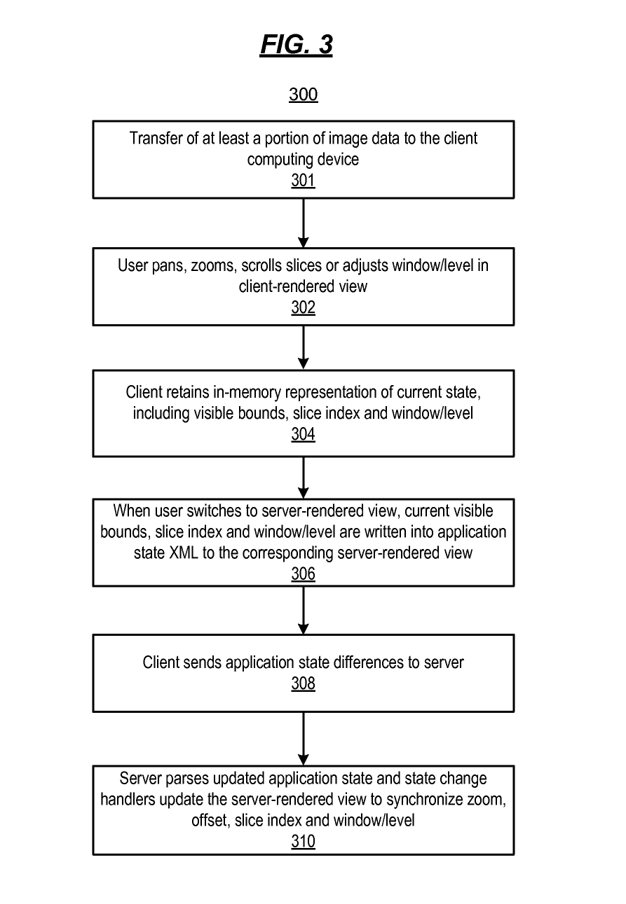

FIG. 3 illustrates an exemplary operational flow 300 of client-to-server synchronization whereby a client may seamlessly switch from client-side rendering to server-side rendering of a medical image. At 301, the process begins after the transfer of at least a portion of image data that is to be rendered by the client device. As such, the client device has begun client-side rendering of images. The slices may be cached in memory such that adjacent slices to a currently displayed slice are locally available as the client switches from client-side rendering to server-side rending. This may enable the client device render image data and present images to a user if a request is made during the transition, as described below. At 302, a user at one of the client devices 112A, 112B, 112C or 112N may perform an operation wherein user pans, zooms, scrolls slices, or adjusts windows/level in a client-rendered view. The client remote access program may update the application state to indicate aspects of current view and/or the state of the client device 112A, 112B, 112C or 112N.

At 304, the client device retains in memory a representation of the current state, including visible bounds, slice index and window/level. At 306, the client device switches to a server rendered view. This may be as a result of a manual switch by the user, whereby a user activates a control on the client device. For example, the image data may be complex and difficult to render on, e.g., the client device 112A, 112B, 112C or 112N. The user may press a control button on the display of the client device to change rendering modes. Alternatively or additionally, it may be automatically determined that the operation at 302 is beyond the capabilities of the client device 112A, 112B, 112C or 112N, or some other parameter, as noted above, is beyond a predetermined threshold. Accordingly, the client device 112A, 112B, 112C or 112N may switch to a server-rendered view automatically. In each scenario, the current visible bounds, slice index and window/level (an image display state) are written into the application state to be used by the imaging and remote access server 105 in the corresponding server rendered view.

At 308, the client remote access program communicates the updated application state differences to the server remote access program. For example, the state model 200 may be communicated between the client device 112A, 112B, 112C or 112N and the imaging and remote access server 105 in order to inform the server remote access program of the current application state at the client device 112A, 112B, 112C or 112N.

At 310, the server remote access program parses the updated state model to determine the application state, and state change handlers update the server rendered view synchronized resume, offset, slice index, and window/level with that of the current state of client device.

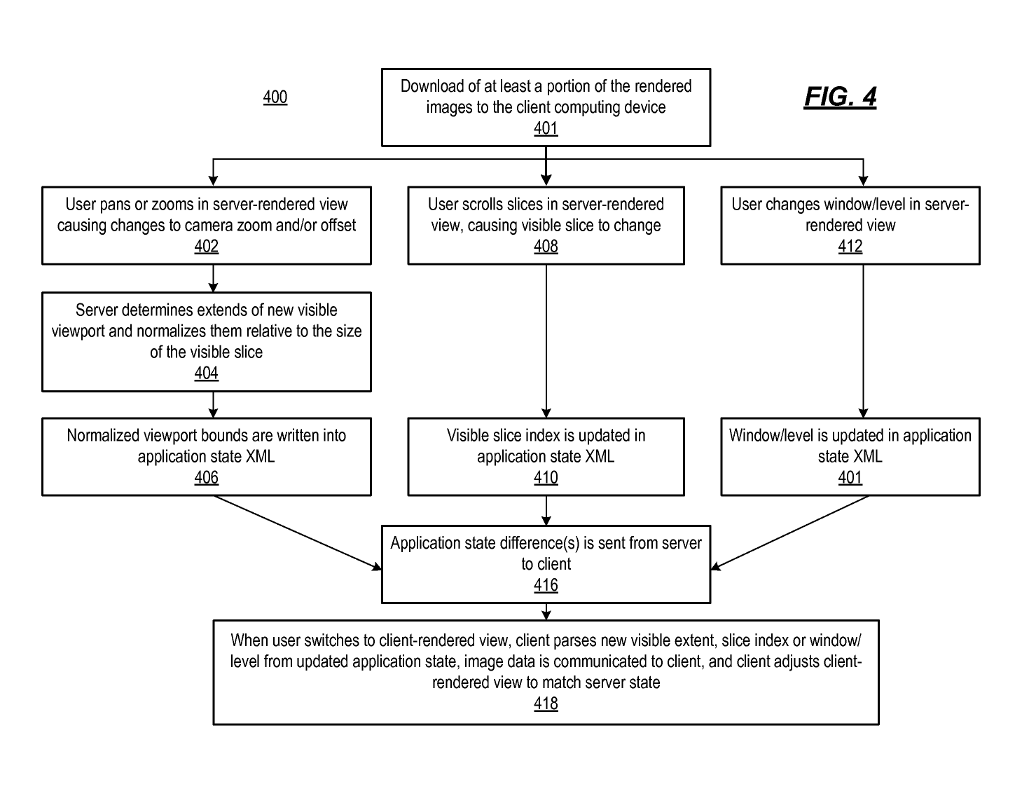

FIG. 4 illustrates an operational flow 400 of server to client synchronization whereby a client may seamlessly switch from server-side rendering to client-side rendering. In the operational flow 400, there may be several scenarios by which the client may switch from server-side rendering to client-side rendering. In each scenario, the process begins at 401 where the download of at least a portion of the rendered images to the client device has begun and a user is viewing the images at the client device. As such, the imaging and remote access server 105 is rendering images for the client device 112A, 112B, 112C or 112N, which is displaying the rendered images to the user. In some implementations, the client device 112A, 112B, 112C or 112N may cache adjacent rendered slices to a currently displayed slice such that the adjacent rendered slices are locally available as the client switches from server-side rendering to client-side rending. This may enable the client device 112A, 112B, 112C or 112N to provide image data to a user if a request is made during the transition, as described below.

For example, in a first scenario, at 402, user pans or zooms in a server rendered view, causing changes to OpenGL camera zoom and/or offset. The client remote access program may update the application state in the state model 200 to indicate the user interaction and communicates the state model 200 to the server remote access program. At 404, the server determines the extents of a new visible viewport and normalizes them relative to the size of the visible slice. At 406, the normalized viewport bounds are written into the application state in the state model 200.

At 416, the application state difference(s) is sent from the server to the client. The application state difference is communicated in state model 200 from the server remote access program to the client device 112A, 112B, 112C or 112N. At 418, with the client device is switched to a client rendered view, the client remote access program may parse the new visible extent, slice index or window/level from the updated application state. Image data is communicated to the client remote access program from the server remote access program so the client rendered view may then be matched the server state.

The switch at 418 may be made as a result of a manual switch by the user, whereby a user activates a control on the client device. For example, the user may be experiencing network problem such that delivery of image data has become unreliable, and the user may press a control button on the display of the client device 112A, 112B, 112C or 112N to download image data from the imaging and remote access server 105 for rendering. Alternatively or additionally, it may be automatically determined that an operation to be performed is within the capabilities of the client device 112A, 112B, 112C or 112N, or some other parameter, as noted above, is within a predetermined threshold. Accordingly, the client device 112A, 112B, 112C or 112N may switch to a client-rendered view automatically. It may also be determined that user-requested operation can be performed at the client device 112A, 112B, 112C or 112N, thus the operation may switch to client-side rendering.

In a second scenario, at 408, a user may scroll slices in a server rendered view, causing visible slice to change. At 410, the visible slice index is updated in the application state in the state model 200. The process then flows to 416 and 418 to match the client rendered view with the server state.

In a third scenario, at 412, the user changes Windows/level in a server rendered view. At 414, the window/level is updated in the application state. It may also be determined that user-requested operation can be performed at the client device 112A, 112B, 112C or 112N, thus the operation may switch to client-side rendering. The process then flows to 416 and 418 to match the client rendered view with the server state.

FIG. 5 illustrates an operational flow 500 of collaboration among plural client devices where at least one of the client devices is performing client-side rendering. At 502, two or more of the client devices 112A, 112B, 112C and 112N enter into a collaborative session. The participating client devices, therefore, will begin to collaboratively interact in the collaborative session with the image data that is communicated from the imaging and remote access server 105. At 504, at least one of the participating ones of the client devices 112A, 112B, 112C and 112N renders the image data from the imaging server client-side. The other client devices 112A, 112B, 112C or 112N may render image data client-side or receive images from the imaging and remote access server 105.

At 506, application state information in the state model is communicated between each of the client devices participating in the collaborative session. The application state information is updated in accordance with user input data received from a user interface program or within the images currently displayed by the client device 112A, 112B, 112C or 112N.

At 508, it is determined if there changes represented in the state model 200. For example, if one of the client devices 112A, 112B, 112C or 112N receives an input that causes a change to the displayed image, that change is captured within the application state and communicated to the others of the client devices 112A, 112B, 112C or 112N in the collaborative session, as well as the imaging and remote access server 105. Each of the other client devices 112A, 112B, 112C or 112N in the collaborative session will, at 504, either render image data to update its respective display to present a synchronized view of the display of the image data, or receive images from the imaging and remote access server 105 to present the synchronized view of the display of the image data. The operational loop that includes step 504-508 continues throughout the collaborative session.

At 508, in accordance with the present disclosure, if more than one change is reflected in the state model 200, conflict resolution may be implemented. For example, a most recent change may take precedence. In some implementations, operational transformation may be used.

Thus, the present disclosure, through the example operational flow 500, provides for collaboration among client devices in a collaborative session where each of the participating client devices is rendering images client-side.

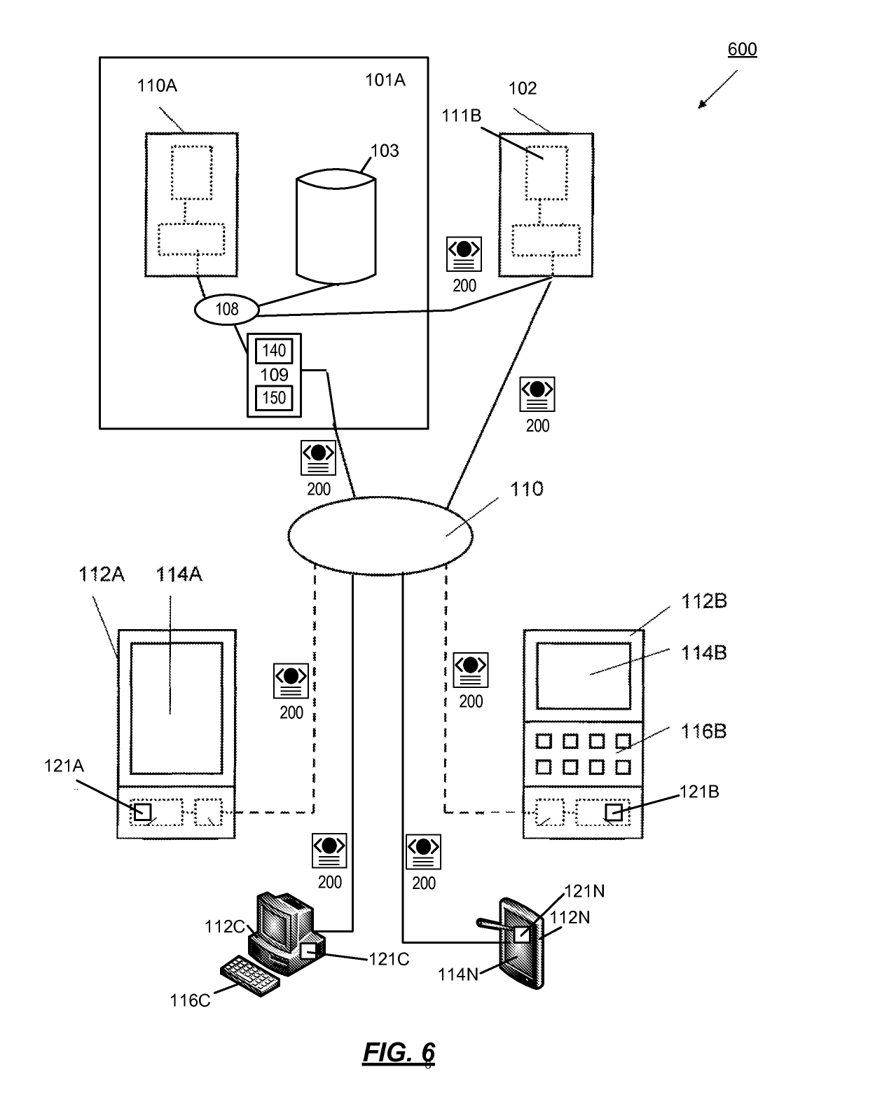

FIG. 6 illustrates another implementation of the environment 100 for image data viewing and collaboration via a computer network. As shown in FIG. 6, functions of the imaging and remote access server 105 of FIG. 1 may be distributed among separate servers, and more particularly to an imaging server 109, which performs the imaging functions and a separate remote access server 102, which performs remote access functions. As an example, the imaging server computer 109 may be provided at a facility 101A (e.g., a hospital or other care facility) within an existing network as part of a medical imaging application to provide a mechanism to access data files, such as patient image files (studies) resident within a, e.g., a Picture Archiving and Communication Systems (PACS) database 103. Using PACS technology, a data file stored in the PACS database 103 may be retrieved and transferred to, for example, a diagnostic workstation 110A using a Digital Imaging and Communications in Medicine (DICOM) communications protocol where it is processed for viewing by a medical practitioner. The diagnostic workstation 110A may be connected to the PACS database 103, for example, via a Local Area Network (LAN) 108 such as an internal hospital network. Metadata may be accessed from the PACS database 103 using a DICOM query protocol, and using a DICOM communications protocol on the LAN 108, information may be shared. The server 109 may comprise a RESOLUTIONMD server available from Calgary Scientific, Inc., of Calgary, Alberta, Canada.

The server 102 is connected to the computer network 110 and includes a server remote access program 111B that is used to connect various client devices (described below) to applications, such as the medical imaging application provided by the server computer 109. For example, the server remote access program 111B may be part of the PUREWEB architecture available from Calgary Scientific, Inc., Calgary, Alberta, Canada, and which includes collaboration functionality.

A client remote access program 121A, 121B, 121C, 121N may be designed for providing user interaction for displaying data and/or imagery in a human comprehensible fashion and for determining user input data in dependence upon received user instructions for interacting with the application program using, for example, a graphical display with touch-screen 114A or a graphical display 114B/114N and a keyboard 116B/116C of client devices 112A, 112B, 112C or 112N, respectively.

In the environment of the present disclosure, the state model 200 may contain information that is continuously passed among the client devices 112A, 112B, 112C or 112N, the server 109 and the server 102, and may contain information such as a current slice being viewed by a user if the user is viewing MR or CT images. The state model 200 may contain other information regarding the capabilities and operating conditions of the client devices 112A, 112B, 112C or 112N, such as CPU type, GPU type, total memory, current CPU utilization, current GPU utilization, current memory utilization, battery life, operating temperature, display size, transmit/receive bit rates, etc. This information and the current slice information noted above may be used to make determinations at the client devices 112A, 112B, 112C or 112N or the remote access server 102 to automatically switch from client-side rendering to server-side rendering and vice-versa during operation. For example, the client remote access programs 121A, 121B, 121C, 121N and/or the server remote access program 111B may examine the capabilities and operating conditions in the state model to determine if the client device 112A, 112B, 112C or 112N is currently capable of client-side rendering. If so, then images are rendered on the client device. If not, then images are rendered on the imaging server 109. In another example, a user of the client device 112A, 112B, 112C or 112N may request an operation (e.g., pan, zoom, scroll) that is beyond the capabilities of the client device 112A, 112B, 112C or 112N. As such, the resulting images based on the requested operation may be rendered on the imaging server 109.

Alternatively or additionally, a user interface program may be executed on the 2imaging server 109 which is then accessed via an URL by a generic client application such as, for example, a web browser executed on the client device 112A, 112B. The user interface is implemented using, for example, Hyper Text Markup Language HTML5. Alternatively or additionally the remote access server 102 may participate in a collaborative session with the client devices 112A, 112B, 112C and 112N. The imaging server 109, remote access server 102 and the client devices 112A, 112B, 112C or 112N may be implemented using hardware such as that shown in the general purpose device of FIG. 7.

Server Side Dicom Caching

If the connection between the client device 112A, 112B, 112C or 112N and the imaging server computer 109 is slow in comparison to the connection between the imaging server computer 109 and the PACS database 103, the user may have to wait until all slices have been transmitted to the client device 112A, 112B, 112C or 112N before the user can scroll through the entire dataset. To address this scenario, in some implementations, DICOM data may be cached in a cache 140 rather than streamed directly to the client device 112A, 112B, 112C or 112N. As such, the client device 112A, 112B, 112C or 112N may exercise more control over the order in which it receives instances. This makes it possible for the user to scroll to a part of the data set that has not yet been downloaded to the client device 112A, 112B, 112C or 112N and to enable the client device 112A, 112B, 112C or 112N to request the slice the user lands on. Thus, the user may only experience a delay when the user scrolls to the last slice received from the PACS database 103, and then has to wait for one slice to be transferred to the client device 112A, 112B, 112C or 112N from the PACS database 103.

Some implementations may require that the server computer 109 to start a service process and load the DICOM data that the user is viewing. The DICOM data may also be transferred to the client device 112A, 112B, 112C or 112N. As such, without caching, the DICOM data is moved from the PACS database 103 twice, once when it is loaded into the service process and once when it is loaded into the client device 112A, 112B, 112C or 112N. Thus, caching, as described above may reduce the load on the PACS database 103. In particular, when utilizing caching, whichever of the above-noted load operations comes first, the server computer 109 may cache the DICOM data. When the second load operation is performed, the server computer 109 need not need load the DICOM data from the PACS database 103 a second time, but rather can retrieve the DICOM data from the cache 140.

In accordance with some implementations, the cache 140 can be used to store computed products as a data to be loaded. Possible computed products include, but are not limited to documents describing how the a series images should be ordered for 2D viewing; how a series of images should be grouped into volumes for 3D and MIP/MPR viewing; and thumbnails for indicating to the user where in the dataset they are while scrolling.

To provide the above functionalities of the cache 140, refactoring may be used to implement the caching of the DICOM data. For example, an interface may be defined to refactor the data from the PACS database 103 in order to make the interception of the DICOM data to be cached more efficient. The interface may also be used to indicate that data is available in the cache 140.

In some implementations, the cache 140 may be Ehcache, which is an open source, standards-based, widely used cache system implemented in Java. Cache consistency checks may be performed to insure that requested instances match instances in the cache 140. If requested instances are missing, they are loaded.

Alternatively or additionally, the cache 140 may provide for consistency. For example, if one client device 112A, 112B, 112C or 112N is being load, and another client device 112A, 112B, 112C or 112N starts the same load before the first load has been completed, a connection to the PACS database 103 may not be open, rather the second load may be performed using data in the cache 140 cache as it becomes available.

Alternatively or additionally, the cache 140 provides a data store that can become a system of record for data derived from other data stored in the cache 140. This data is valid and useful as long as the source data is also in the cache 140.

On Demand Slice Loading/Buffering Mechanism

In some implementations, a data buffering/loading mechanism may be provided where data is transcoded and stored on the server computer 109 in a server-side buffer 150. Once loaded the client device 112A, 112B, 112C or 112N has the ability to request particular instances for loading. Such an implementation allows for retrieving of missing client side slices and for pulling client side slices that the user may be interested in viewing, e.g., if a user scrolls at the client as the server computer 109 caches, the server computer 109 may prioritize the closest slices.

Alternatively or additionally, a client side buffering of transcoded images may be performed to reduce load on the PACS database 103 or server computer 109 for multiple views of a dataset.

In some implementations, analytics may be provided at the client device 112A, 112B, 112C or 112N in the client remote access program 121A, 121B, 121C, 121N. For example, page views may be triggered whenever a view controller is triggered to provide an indication that data is to be pulled out of the buffer 150 or PACS database 103.

In some implementations logging may be added to provide HIPAA compliance. For example, application activity, authentication, queries against the PACS database 103, and instances transferred may be logged. Logging may be performed to flat files or databases.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

FIG. 7 shows an exemplary computing environment in which example embodiments and aspects may be implemented. The computing system environment is only one example of a suitable computing environment and is not intended to suggest any limitation as to the scope of use or functionality.

With reference to FIG. 7, an exemplary system for implementing aspects described herein includes a device, such as device 700. In its most basic configuration, device 700 typically includes at least one processing unit 702 and memory 704. Depending on the exact configuration and type of device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Device 700 may have additional features/functionality. For example, device 700 may include additional storage (removable and/or non-removable) including, but not limited to, magnetic or optical disks or tape. Such additional storage is illustrated in FIG. 7 by removable storage 708 and non-removable storage 710.

Device 700 typically includes a variety of computer readable media. Computer readable media can be any available media that can be accessed by device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 700. Any such computer storage media may be part of device 700.

Device 700 may contain communications connection(s) 712 that allow the device to communicate with other devices. Device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of client-server synchronization of a view of image data during client-side image data rendering comprising:
performing client-side rendering of the image data and updating an application state to indicate aspects of a current view being displayed on the client device;
retaining a representation of a current view in memory at the client device;
writing the current view into the application state; and
communicating the application state from the client device to a server.

2. The method of claim 1, further comprising switching to server-side rendering of the image data by utilizing the application state communicated to the server.

3. The method of claim 2, wherein the switching is performed as a result of a user interaction with a control.

4. The method of claim 2, wherein the switching is performed automatically in accordance with predetermined criteria, the predetermined criteria being one of CPU type, GPU type, total memory, current CPU utilization, current GPU utilization, current memory utilization, battery life, operating temperature, display size, and transmit/receive bit rate.

5. The method of claim 2, further comprising caching the image data at the client device such that a predetermined number of images are locally available at the client device as the switching is performed.

6. The method of claim 1, wherein the current view comprises at least one of a current visible bounds, an offset, a slice index and a window/level of a current display at the client device.

7. The method of claim 1, further comprising synchronizing at least one of an offset, slice index, and a window/level in the server-side rendered view with the current view being displayed at the client device.

8. The method of claim 7, further comprising retaining an in memory representation of at least one of the current visible bounds, the offset, the slice index and the window/level of the current display prior to performing switching.

9. The method of claim 1, further comprising:
initially performing server-side rendering of the image data;
switching the client device to the client-side rendering of the image data, the switching comprising:
communicating the application state from the server; and
utilizing differences in the application state at the client device to begin client-side rendering of the image data such that the client-side rendering of the image data is synchronized with a last rendered view provided by the server.

10. The method of claim 9, wherein the switching is performed as a result of a user interaction with a control.

11. The method of claim 9, wherein the switching is performed automatically in accordance with predetermined criteria, the predetermined criteria being one of CPU type, GPU type, total memory, current CPU utilization, current GPU utilization, current memory utilization, battery life, operating temperature, display size, and transmit/receive bit rate.

12. The method of claim 9, further comprising synchronizing at least one of an offset, slice index, and a window/level in the client-side rendered view with the last rendered view being displayed at the client device.

13. The method of claim 9, further comprising caching, at the client device, images associated with the images being rendered at the server such that the images associated with the images being rendered at the server are locally available as the switching is performed.

14. The method of claim 1, further comprising:
providing a collaboration mode in which the current view is displayed by each of plural client devices in a collaborative session; and
continuously communicating the application state among the plural client devices in the collaboration session.

15. The method of claim 14, further comprising:
receiving a user input at one of the plural client devices;
updating the current view in response to the user input to render an updated current view;
updating the application state to include the updated current view;
communicating the updated application state to others of the plural client devices; and
rendering the updated current view at each of other of the plural client devices or receiving an image representative of the updated current view to display the updated displayed image at each of other of the plural client devices.

16. A method of client-to-server synchronization by which a client device seamlessly switches from client-side rendering of image data to server-side rendering of image data or vice-versa, at least a portion of the image data being downloaded from a server to the client device, comprising:
updating an application state to indicate aspects of a current view being displayed on the client device;
retaining a representation of a current view in memory at the client device;
when performing client-side rendering, switching the client device to server-side rendering of the image data, the switching comprising:
writing the current view into the application state; and
communicating the application state from the client device to server for utilization of the application state at the server to begin server-side rendering of the image synchronized with the current view; and
when performing server-side rendering, switching the client device to client-side rendering of the image data, the switching comprising:
communicating the application state from the server; and
utilizing differences in the application state at the client device to begin client-side rendering of the image data such that the client-side rendering of the image data is synchronized with a last rendered view provided by the server.

17. The method of claim 16, wherein the switching is performed automatically in accordance with predetermined criteria, the predetermined criteria including at least one of CPU type, GPU type, total memory, current CPU utilization, current GPU utilization, current memory utilization, battery life, operating temperature, display size, and transmit/receive bit rate.

18. The method of claim 16, wherein the current view comprises at least one of a current visible bounds, an offset, a slice index and a window/level of a current display at the client device.

19. A method of synchronization of displayed images by each of plural client devices in a collaborative session, at least a portion of the image data being downloaded from a server to the client devices, comprising:
rendering image data at each of the plural client devices for display at each of the plural client devices;
updating an application state at each of the plural client devices to indicate a display state associated with the images being displayed at each of the plural client devices;
continuously communicating the application state among the plural client devices and the server; and
synchronizing the currently displayed image at each of the plural client devices in accordance with the display state at one of the plural client devices.

20. The method of claim 19, further comprising:
receiving a user input at one of the plural client devices;
updating the currently displayed image in response to the user input to render an updated displayed image;
updating the application state in response to the user input;
communicating the updated application state to the plural client devices and the server; and
rendering the image data at each of other of the plural client devices to display the updated displayed image at each of other of the plural client devices.
